(19) United States
(12) Patent Application Publication
(10) Pub. No.: US 2016/0285383 A1
(43) Pub. Date: Sep. 29, 2016

(54) POWER CONVERSION DEVICE AND CONVERSION METHOD THEREOF

(71) Applicant: HEP TECH CO.,LTD, Taichung City, (TW)

(72) Inventors: CHING-TSAI PAN, Hsinchu City (TW); PO-YEN CHEN, Taipei City (TW); TA-SHENG HUNG, Taichung City (TW)

(21) Appl. No.: 15/037,475

(22) PCT Filed: Oct. 15, 2014
(86) PCT No.: PCT/CN2014/000913

§ 371 Date: May 18, 2016

(30) Foreign Application Priority Data
Nov. 18, 2013 (CN) 201310581016.1

(51) Int. Cl. H02M 7/04; H02M 1/14; H02M 1/42

(52) U.S. Cl. CPC H02M 7/04; H02M 1/42; H02M 1/14

(57) ABSTRACT

A power conversion device is provided, which includes a first inductor (L1), switch assembly (20), diode (D), first capacitor (C1), second inductor (L2) and a second capacitor (C2). One end of the first capacitor is connected to the positive terminal (12) of a DC power source (300). One end of the switch assembly is connected to the other end of the first inductor, and the other end is connected to the negative terminal (14) of the DC power source. The positive electrode of the diode is connected to the switch assembly. One end of the first capacitor is connected to the negative electrode of the diode. The second inductor is connected in parallel with the first capacitor. The second capacitor is connected in parallel with a load (200), one end of the capacitor is connected to the second inductor, and the other end is connected to the negative terminal.

### TECHNICAL FIELD

The present disclosure relates to power conversion, in particular to a power conversion device and the conversion method thereof.

### BACKGROUND

In general, a conventional power conversion device is to connect an output capacity to the output of a power source to connect to a load so as to achieve the power conversion by directly charging/discharging the capacitor. Take AC-DC power conversion as an example, the output capacitor is usually connected to a rectifier circuit for converting the AC electricity energy into the DC electricity energy.

However, when the aforementioned AC-DC power conversion device is in operation, the phase of the input voltage of the AC power source tends to be different with that of the input current of the AC power source, which will reduce the power factor and further deteriorate the total harmonic distortion.

In addition, the rectifier circuit will not charge the output capacitor unless the output voltage of the rectifier circuit is higher than the voltage of the output capacitor; accordingly, the charging time of the output capacitor will be reduce, and the on time of the diode in the rectifier circuit will also be reduced to further increase the peak value of the turn-on current, which will not only distort the waveform of the input current and reduce the power factor, but also will further deteriorate the distortion of the electricity energy outputted to the load.

Therefore, the above conventional power conversion device still has a lot of shortcomings and defects in structure and use needed to be further improved. In order to solve the above problems, a lot of circuit designers have kept trying hard to find a solution, but a proper solution has yet to be successfully developed until now; besides, the currently available products have no proper structure to solve the above problems; thus, the above problems currently have become important issues to be solved.

### SUMMARY

In view of above, the object of the present invention is to provide a power conversion device and the conversion method thereof, which cannot only effectively increase the power factor, but also can effectively depress the voltage ripple outputted to the load.

The object of the present invention can be realized by adopting the following technical schemes. The present invention provides a power conversion device for DC-DC power conversion so as to convert the electricity energy of a DC power source and then supply the electricity energy to a load; the DC power source has a positive terminal and a negative terminal; the power conversion device includes a first inductor, a switch assembly, a diode, a first capacitor, a second inductor and a second capacitor. More specifically, one end of the first inductor is connected to the positive terminal. One end of the switch assembly is connected to the other end of the first inductor, and the other end of the switch assembly is connected to the negative terminal. The positive electrode of the diode is connected to the junction of the switch assembly and the first inductor. One end of the first capacitor is connected the negative electrode of the diode. One end of the second inductor is connected to the junction of the first capacitor and the negative electrode of the diode, and the other end of the second inductor is connected to the other end of the first capacitor. The second capacitor is connected to the load in parallel; one end of the second capacitor is connected to the junction of the other end of the second inductor and the other end of the first capacitor, and the other end of the second capacitor is connected to the junction of the switch assembly and the negative terminal.

The object of the present invention can be further realized by adopting the following technical schemes.

The aforementioned power conversion device, wherein the switch assembly includes an electronic switch and an intrinsic diode connected in parallel; one end of the electronic switch and the negative electrode of the intrinsic diode are simultaneously connected to the other end of the first inductor, and the other end of the electronic switch and the positive electrode of the intrinsic diode are simultaneously connected to the negative terminal.

The object of the present invention can be further realized by adopting the following technical schemes. The present invention further provides a DC-DC power conversion method for a power conversion device, which includes the following steps:

A. turning on the electronic switch to charge the first inductor by the electricity energy outputted from the DC power source, and making the second inductor, the first capacitor and the second capacitor keep powering the load;

B. turning off the electronic switch to charge the second inductor, the first capacitor and the second capacitor by the first inductor, and making the second capacitor keep powering the load;

C. when the first inductor stops charging the second inductor, the first capacitor and the second capacitor by the first inductor, charging the first capacitor by the second inductor to reverse the polarity of the voltage across the first capacitor, and making the second capacitor keep powering the load;

D. turning on the intrinsic diode to reverse the polarity of the voltage across the first capacitor and the second inductor to charge the second capacitor, and making the second capacitor keep powering the load.

The object of the present invention can be further realized by adopting the following technical schemes.

The aforementioned power conversion method, wherein the method further includes a step after the step D, and the step is to repeat executing the step A to the step D.

The aforementioned power conversion method, wherein the first inductor charges the second capacitor via a resonant circuit formed by the first capacitor and the second inductor in the step B.

The aforementioned power conversion method, wherein the second inductor powers the first capacitor in the step C after the first capacitor and the second inductor form the resonant circuit so as to reverse the polarity of the voltage across the second capacitor, and the intrinsic diode is turned on when the voltage across the second inductor is higher than the voltage across the second capacitor, and then the method proceeds to the step D.

The object of the present invention can be further realized by adopting the following technical schemes. The present invention provides a power conversion device for AC-DC power conversion so as to convert the electricity energy of an AC power source and then supply the electricity energy to a load; the power conversion device includes a rectifier circuit, a first inductor, a switch assembly, a diode, a first capacitor, a second inductor and a second capacitor. More specifically, the rectifier circuit has an input side and an output side; the input side is electrically connected to the AC power source to convert the electricity energy of the AC power source into a DC electricity energy and then output the DC electricity energy from the output side; in addition, the output side has a positive terminal and a negative terminal according to the polarity of the DC electricity energy outputted. One end of the first inductor is connected to the positive terminal. One end of the switch assembly is connected to the other end of the first inductor, and the other end of the switch assembly is connected to the negative terminal. The positive electrode of the diode is connected to the junction of the switch assembly and the first inductor. One end of the first capacitor is connected the negative electrode of the diode. One end of the second inductor is connected to the junction of the first capacitor and the negative electrode of the diode, and the other end of the second inductor is connected to the other end of the first capacitor. The second capacitor is connected to the load in parallel; one end of the second capacitor is connected to the junction of the other end of the second inductor and the other end of the first capacitor, and the other end of the second capacitor is connected to the junction of the switch assembly and the negative terminal.

The object of the present invention can be further realized by adopting the following technical schemes.

The aforementioned power conversion device, wherein the switch assembly includes an electronic switch and an intrinsic diode connected in parallel; one end of the electronic switch and a negative electrode of the intrinsic diode are simultaneously connected to the other end of the first inductor, and the other end of the electronic switch and a positive electrode of the intrinsic diode are simultaneously connected to the negative terminal.

The object of the present invention can be further realized by adopting the following technical schemes. The present invention further provides a AC-DC power conversion method of a power conversion device, which includes the following steps:

A. turning on the electronic switch to charge the first inductor by the DC electricity energy outputted from the rectifier circuit, and making the second inductor, the first capacitor and the second capacitor keep powering the load;

B. turning off the electronic switch to charge the second inductor, the first capacitor and the second capacitor by the first inductor, and making the second capacitor keep powering the load;

C. when the first inductor stops charging the second inductor, the first capacitor and the second capacitor, charging the first capacitor by the second inductor to reverse the polarity of the voltage across the first capacitor, and making the second capacitor keep powering the load;

D. turning on the intrinsic diode to reverse the polarity of the voltage across the first capacitor and the second inductor to charge the second capacitor, and making the second capacitor keep powering the load.

The object of the present invention can be further realized by adopting the following technical schemes.

The aforementioned power conversion method, wherein the method further includes a step after the step D, and the step is to repeat executing the step A to the step D.

The aforementioned power conversion method, wherein the first inductor charges the second capacitor via a resonant circuit formed by the first capacitor and the second inductor in the step B.

The aforementioned power conversion method, wherein the second inductor powers the first capacitor in the step C after the first capacitor and the second inductor form the resonant circuit so as to reverse the polarity of the voltage across the second capacitor, and the intrinsic diode is turned on when the voltage across the second inductor is higher than the voltage across the second capacitor, and then the method proceeds to the step D.

By means of the above technical schemes, the power conversion device and the conversion method thereof in accordance with the present invention have at least the following advantages and beneficial effects: the power conversion device and the conversion method thereof in accordance with the present invention cannot only effectively increase the power factor, but also can effectively depress the voltage ripple outputted to the load.

Further scope of applicability of the present application will become more apparent from the detailed description given hereinafter. However, it should be understood that the detailed description and specific examples, while indicating exemplary embodiments of the disclosure, are given by way of illustration only, since various changes and modifications within the spirit and scope of the disclosure will become apparent to those skilled in the art from this detailed description.

### BRIEF DESCRIPTION OF THE DRAWINGS

FIG. 1 is a circuit diagram of a first preferred embodiment in accordance with the present invention.

FIG. 2-FIG. 5 are the equivalent circuit diagrams of each of the steps of FIG. 1.

FIG. 6 is a circuit diagram of a second preferred embodiment in accordance with the present invention.

### DETAILED DESCRIPTION

The technical content of the present invention will become apparent by the detailed description of the following embodiments and the illustration of related drawings as follows.

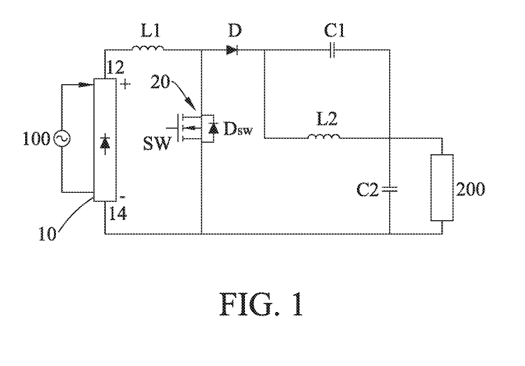

Please refer to FIG. 1, which is a power conversion device of a first preferred embodiment in accordance with the present invention for converting the electricity energy of an AC power source 100 and then supplying the electricity energy to a load 200, and the power conversion device includes a rectifier circuit 10, a switch assembly 20, an independent diode D, two inductors (the first inductor L1 and the second inductor L2) and two capacitor (the first capacitor C1 and the second capacitor C2). The connection relations of the above components are described as follows:

In the embodiment, the rectifier circuit 10 is a bridge rectifier, and its input side is electrically connected to the AC power source 100 for receiving the electricity energy from the AC power source 100 and then converting the electricity energy of the AC power source into the DC electricity energy and then output the DC electricity energy from its output side; in addition, the output side has a positive terminal 12 and a negative terminal 14 according to the polarity of the DC electricity energy outputted. Of course, in addition to the bridge rectifier, other rectifier circuits can be used to achieve the same object, such as center-tapped type, vacuum-tube type and the like.

One end of the first inductor L1 is connected to the positive terminal 12.

One end of the switch assembly 20 is connected to the other end of the first inductor L1, and the other end is connected to the negative terminal 14. In the embodiment, the switch assembly 20 includes an electronic switch SW and an intrinsic diode Dsw; one end of the electronic switch SW and the negative electrode of the intrinsic diode Dsw are simultaneously connected to the other end of the first inductor L1, and the other end of the electronic switch SW and the positive electrode of the intrinsic diode Dsw are simultaneously connected to the negative terminal 14.

The positive electrode of the diode D is connected to the junction of the electronic switch SW and the first inductor L1.

One end of the first capacitor C1 is connected the negative electrode of the diode D.

One end of the second inductor L2 is connected to the junction of the first capacitor C1 and the negative electrode of the diode D, and the other end is connected to the other end of the first capacitor C1.

The second capacitor C2 is connected to the load 200 in parallel; one end is connected to the junction of the other end of the second inductor L2 and the other end of the first capacitor C1, and the other end is connected to the junction of the electronic switch SW and the negative terminal 14.

In the embodiment, the specification of the capacitors C1˜C2, the inductors L1˜L2, the input voltage, the output voltage, the switching frequency of the electronic switch SW and the load is as shown in the following table:

| | | |
|---|---|---|
| First inductor L1 | 200 | μH |
| Second inductor L2 | 350 | μH |
| First capacitor C1 | 8 | nF |
| Second capacitor C2 | 10 | μF |
| Input voltage Vin | 150 | V |
| Output voltage Vout | 180 | V |
| Switching frequency | 100 | KHz |

| | |
|---|---|
| Load resistance | 100Ω |

Via the above structure design, the specification and the following power conversion method, the object of bettering the power conversion efficiency can be achieved, and the method includes the following steps:

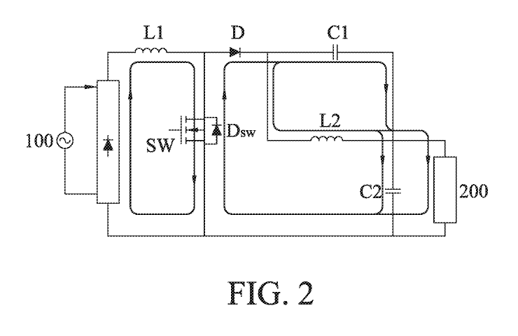

A. please refer to FIG. 2, turning on the electronic switch to charge the first inductor by the DC electricity energy outputted from the rectifier circuit, and making the second inductor, the first capacitor and the second capacitor keep powering the load;

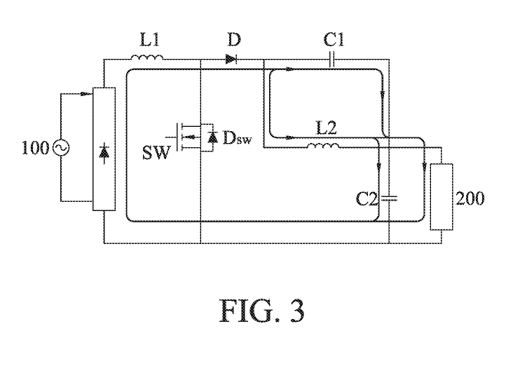

B. please refer to FIG. 3, turning off the electronic switch to charge the second inductor and the first capacitor by the first inductor, and charging the second capacitor C2 by the resonant circuit form by the first capacitor C1 and the second inductor L2 to make the second capacitor C2 keep powering the load 200;

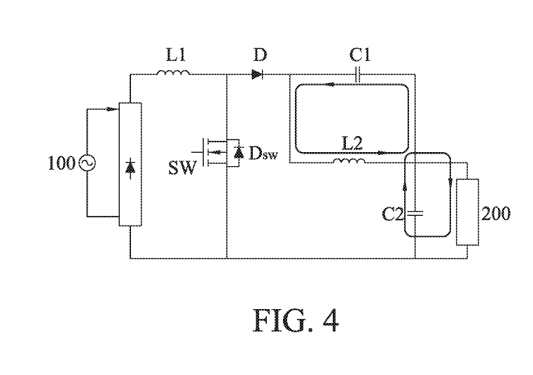

C. please refer to FIG. 4, when the first inductor stops charging the second inductor, the first capacitor and the second capacitor, charging the first capacitor by the second inductor to reverse the polarity of the voltage across the first capacitor, and making the second capacitor keep powering the load;

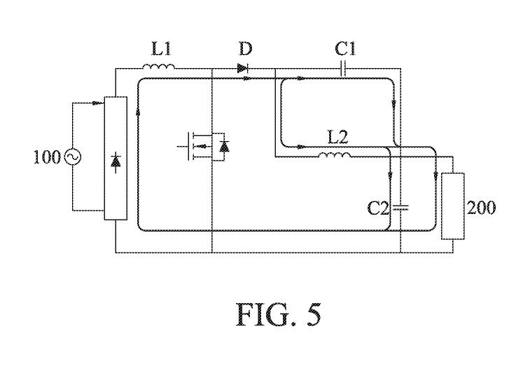

D. please refer to FIG. 5, when the voltage across the second inductor is higher than the voltage across the second capacitor, turning on the intrinsic diode to reverse the polarity of the voltage across the first capacitor and the second inductor to charge the second capacitor, and making the second capacitor keep powering the load.

After each of the step A˜step D is executed for one time, it means one operation cycle is finished. Thus, when the power conversion device keeps being in operation, the step A˜step D will be repeatedly executed after the step D until the power conversion device is turned off.

By means of the above design, in each operation cycle, the voltage across the first capacitor C1 can automatically provide negative potential to turn on the intrinsic diode Dsw to completely change the circuit, which can achieve swift response and low-ripple output voltage; in the meanwhile, the switching of the electronic switch SW can increase the power factor.

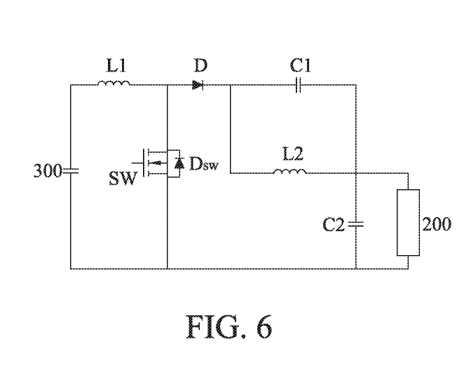

Moreover, the present invention is not limited to the application of the AC-DC power conversion; as shown in FIG. 6, the rectifier circuit 10 can be removed, and the device can be directly connected to the positive terminal and the negative terminal of the DC power source 300, which can also increase the power factor, and achieve swift response and low-ripple output voltage.

It will be apparent to those skilled in the art that various modifications and variations can be made to the disclosed embodiments. It is intended that the specification and examples be considered as exemplary only, with a true scope of the disclosure being indicated by the following claims and their equivalents.

What is claimed is:

1. A power conversion device for converting an electricity energy of a DC power source and then supply the electricity energy to a load, and the DC power source having a positive terminal and a negative terminal, wherein the power conversion device is characterized in comprising:
a first inductor, one end of the first inductor being connected to the positive terminal;
a switch assembly, one end of the switch assembly being connected to the other end of the first inductor, and the other end of the switch assembly being connected to the negative terminal;
a diode, a positive electrode of the diode being connected to a junction of the switch assembly and the first inductor;
a first capacitor, one end of the first capacitor being connected a negative electrode of the diode;
a second inductor, one end of the second inductor being connected to a junction of the first capacitor and the negative electrode of the diode, and the other end of the second inductor being connected to the other end of the first capacitor; and
a second capacitor, connected to the load in parallel; one end of the second capacitor being connected to a junction of the other end of the second inductor and the other end of the first capacitor, and the other end of the second capacitor being connected to a junction of the switch assembly and the negative terminal.

2. The power conversion device of claim 1, characterized in that the switch assembly comprises an electronic switch and an intrinsic diode connected in parallel; one end of the electronic switch and a negative electrode of the intrinsic diode are simultaneously connected to the other end of the first inductor, and the other end of the electronic switch and a positive electrode of the intrinsic diode are simultaneously connected to the negative terminal.

3. A power conversion method of the power conversion device of claim 2, characterized in comprising the following steps:
A. turning on the electronic switch to charge the first inductor by the electricity energy outputted from the DC power source, and making the second inductor, the first capacitor and the second capacitor keep powering the load;
B. turning off the electronic switch to charge the second inductor, the first capacitor and the second capacitor by the first inductor, and making the second capacitor keep powering the load;
C. when the first inductor stops charging the second inductor, the first capacitor and the second capacitor by the first inductor, charging the first capacitor by the second inductor to reverse a polarity of a voltage across the first capacitor, and making the second capacitor keep powering the load;
D. turning on the intrinsic diode to reverse a polarity of a voltage across the first capacitor and the second inductor to charge the second capacitor, and making the second capacitor keep powering the load;

4. The power conversion method of claim 3, characterized in further comprising a step after the step D, and the step being to repeat executing the step A to the step D.

5. The power conversion method of claim 3, characterized in that the first inductor charges the second capacitor via a resonant circuit formed by the first capacitor and the second inductor in the step B.

6. The power conversion method of claim 5, characterized in that the second inductor powers the first capacitor in the step C after the first capacitor and the second inductor form the resonant circuit so as to reverse a polarity of a voltage across the second capacitor, and the intrinsic diode is turned on when a voltage across the second inductor is higher than the voltage across the second capacitor, and then the method proceeds to the step D.

7. A power conversion device for converting an electricity energy of an AC power source and then supply the electricity energy to a load, characterized in comprising:
a rectifier circuit, having an input side and an output side, and the input side being electrically connected to the AC power source to convert the electricity energy of the AC power source into a DC electricity energy and then output the DC electricity energy from the output side; the output side having a positive terminal and a negative terminal according to a polarity of the DC electricity energy outputted;
a first inductor, one end of the first inductor being connected to the positive terminal;
a switch assembly, one end of the switch assembly being connected to the other end of the first inductor, and the other end of the switch assembly being connected to the negative terminal;
a diode, a positive electrode of the diode being connected to a junction of the switch assembly and the first inductor;
a first capacitor, one end of the first capacitor being connected a negative electrode of the diode;
a second inductor, one end of the second inductor being connected to a junction of the first capacitor and the negative electrode of the diode, and the other end of the second inductor being connected to the other end of the first capacitor; and
a second capacitor, connected to the load in parallel; one end of the second capacitor being connected to a junction of the other end of the second inductor and the other end of the first capacitor, and the other end of the second capacitor being connected to a junction of the switch assembly and the negative terminal.

8. The power conversion device of claim 7, characterized in that the switch assembly comprises an electronic switch and an intrinsic diode connected in parallel; one end of the electronic switch and a negative electrode of the intrinsic diode are simultaneously connected to the other end of the first inductor, and the other end of the electronic switch and a positive electrode of the intrinsic diode are simultaneously connected to the negative terminal.

9. A power conversion method of the power conversion device of claim 8, characterized in comprising the following steps:
A. turning on the electronic switch to charge the first inductor by the DC electricity energy outputted from the rectifier circuit, and making the second inductor, the first capacitor and the second capacitor keep powering the load;
B. turning off the electronic switch to charge the second inductor, the first capacitor and the second capacitor by the first inductor, and making the second capacitor keep powering the load;
C. when the first inductor stops charging the second inductor, the first capacitor and the second capacitor, charging the first capacitor by the second inductor to reverse a polarity of a voltage across the first capacitor, and making the second capacitor keep powering the load;
D. turning on the intrinsic diode to reverse a polarity of a voltage across the first capacitor and the second inductor to charge the second capacitor, and making the second capacitor keep powering the load.

10. The power conversion method of claim 9, characterized in further comprising a step after the step D, and the step being to repeat executing the step A to the step D.

11. The power conversion method of claim 9, characterized in that the first inductor charges the second capacitor via a resonant circuit formed by the first capacitor and the second inductor in the step B.

12. The power conversion method of claim 11, characterized in that the second inductor powers the first capacitor in the step C after the first capacitor and the second inductor form the resonant circuit so as to reverse a polarity of a voltage across the second capacitor, and the intrinsic diode is turned on when a voltage across the second inductor is higher than the voltage across the second capacitor, and then the method proceeds to the step D.
